(19) United States
(12) Patent Application Publication
(10) Pub. No.: US 2007/0090240 A1
(43) Pub. Date: Apr. 26, 2007

(54) Personal items holder adapted for mounting on a surface

(75) Inventor: Carole Loveless, Las Vegas, NV (US)

Correspondence Address: HOFFMANN & BARON, LLP, 6900 JERICHO TURNPIKE, SYOSSET, NY, 11791, US

(73) Assignee: JACKNOB CORP.

(21) Appl. No.: 11/254,491

(22) Filed: Oct. 20, 2005

(51) Int. Cl. F16M 11/00

(52) U.S. Cl. 248/200

(57) ABSTRACT

A device for providing temporary storage of personal items, particularly in restrooms. The device comprises a bracket with a top and bottom flat portion for mounting and a middle portion that protrudes from a mounting surface to create a storage area to contain personal items. The bracket can be made of transparent, translucent, or even solid colored materials. Also, the bracket can have a tapered width to facilitate use of the device, but most notably should have open sides to allow unobstructed access to said storage area from beyond said bracket. The device should be light and easy to secure to most mounting surfaces.

### BACKGROUND OF THE INVENTION

1. Field of the Invention

The present invention relates generally to the field of temporary storage devices and more particularly to those devices used in public restrooms for holding the personal item(s) of an individual while using the restroom.

2. Brief Description of the Related Art

Devices have been used for providing temporary storage of personal items of restroom visitors. It is well known that restroom visitors at times find it helpful to have a place to temporarily store personal items while they use those facilities. Such devices have taken the form of a common hook or shelf that is either mounted or installed somewhere inside the restroom. In particular, it is not uncommon to find at least a hook on the inside of a bathroom stall. Also, more elaborate hooks, shelves and holders have been used in this capacity.

Hook-style holders while generally being inexpensive and rather simple to install, are ineffective to visitors carrying personal items that can not be hung on a hook. This leaves such visitors with the problem of either having to hold onto such items or place them on a bathroom fixture or the floor. Such solutions are often messy, and can lead to placing items in a location where the items can easily be forgotten.

Shelves also have their disadvantages. While they can hold many items that can not take advantage of a hook, they are often cumbersome, expensive and difficult to install. Also, shelves can be too weighty for application in a restroom stall or other lightweight wall construction. While the weight of the shelf itself and the anticipated items can be heavy, many visitors also have a tendency to bump into or lean on shelves which can overload the supporting wall mounts. Further, the narrow and confining area inside a bathroom stall can lead a user to accidentally knock things off a shelf, which can damage such items.

### SUMMARY OF THE INVENTION

The present invention provides a personal items holder, with particular application in a public restroom, that is adapted for holding numerous items that can not be placed on a hook, is lightweight, and minimizes the load on the supporting wall structure.

Another aspect of the present invention is to provide a personal items holder that keeps such items clean, safe and readily seen by their owner.

Yet another aspect of the present invention is to provide a personal items holder that is easy to install and can be used on lightweight walls, minimizing the load placed on the supporting wall and mounting structures.

Yet another aspect of the present invention is to provide a personal items holder that is simple, inexpensive to manufacture and has diverse application.

Briefly described according to one embodiment of the current invention, a personal items holder is disclosed comprises a plurality of integrally joined flat sections including a top, bottom and middle portion. The top and bottom portions are each adapted to be mounted to a plurality of mounting surfaces. Thus, the top or bottom portions can be mounted on a restroom stall wall or door. One end of the middle portion is joined to the top portion and the other end of the middle portion is joined to the bottom portion. Also, the middle portion extends outwardly from either the top portion or the bottom portion, defining a storage space that has unobstructed opposing side openings. No substantially flat member joins the top portion to the bottom portion. In this way, there is unimpeded access through the storage area from either side opening. Furthermore, a mounting device is provided for securing either or both of the top or bottom portions to at least one surface.

Briefly described according to a further embodiment of the current invention, the personal items holder can be made from a one-piece casing or bracket manufactured from acrylic or plastic sheeting. All or part of the bracket can be transparent, translucent or opaque. The bracket can have a tapered section comprising a narrower end and an opposed wider end, and the tapered section can be the middle portion. Also at least part of the bracket can display a message or image. Further, the middle portion can comprise a plurality of flat sections. Further still, both the top and bottom portions can be mounted to surfaces and they can both be mounted to the same surface. The mounting device can comprise a fastener mounting the casing to the surface through an aperture in the bracket.

These and other objectives, features, and advantages of this invention will become apparent from the following detailed description of illustrative embodiments thereof, which is to be read in connection with the accompanying drawings.

### BRIEF DESCRIPTION OF THE DRAWINGS

FIG. 1 shows a right-side perspective view of a personal items holder in accordance with the present invention, mounted on a wall and containing a handbag.

FIG. 2 shows a left-side perspective view of the personal items holder, also mounted on a wall and containing a handbag;

FIG. 3 shows a front view of the personal items holder, also mounted on a wall and containing a handbag;

FIG. 4 shows a front view of the personal items holder without any contents;

FIG. 5 shows a side view of the personal items holder without any contents.

### DETAILED DESCRIPTION OF THE PREFERRED EMBODIMENTS

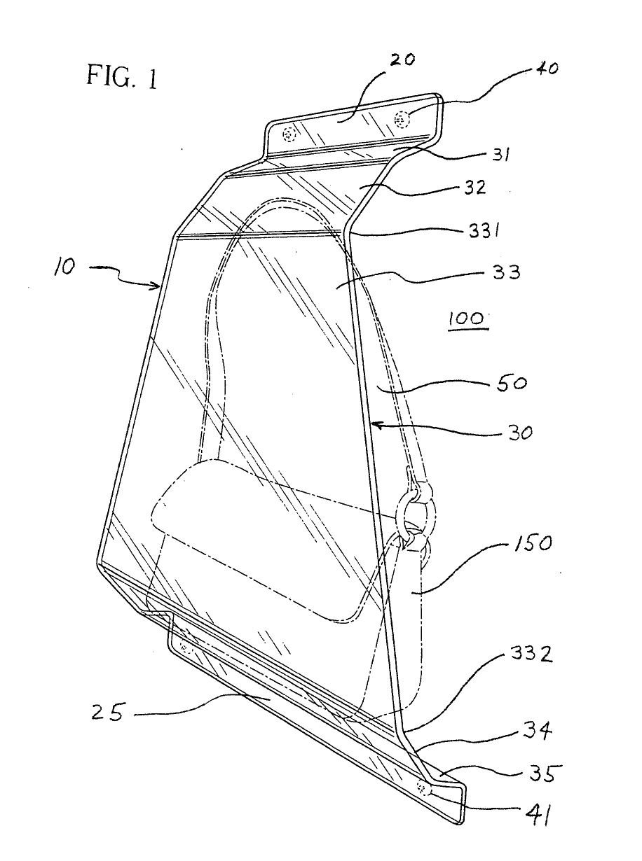

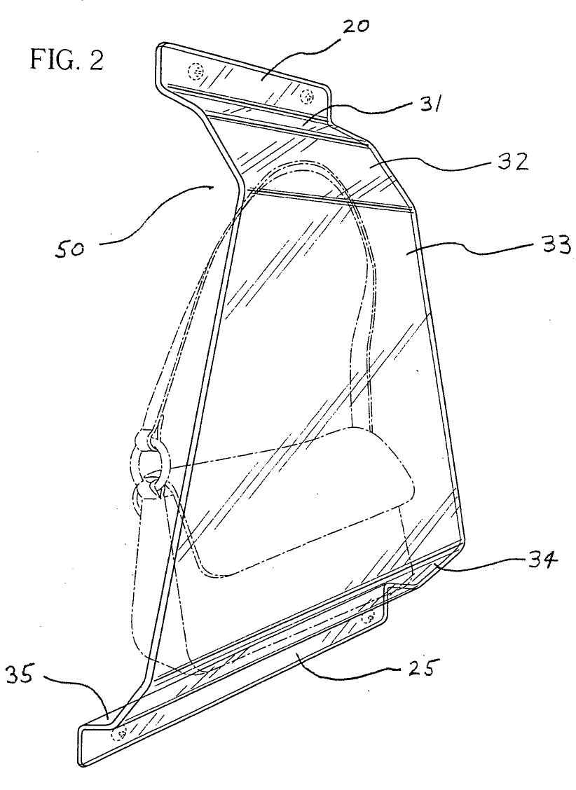

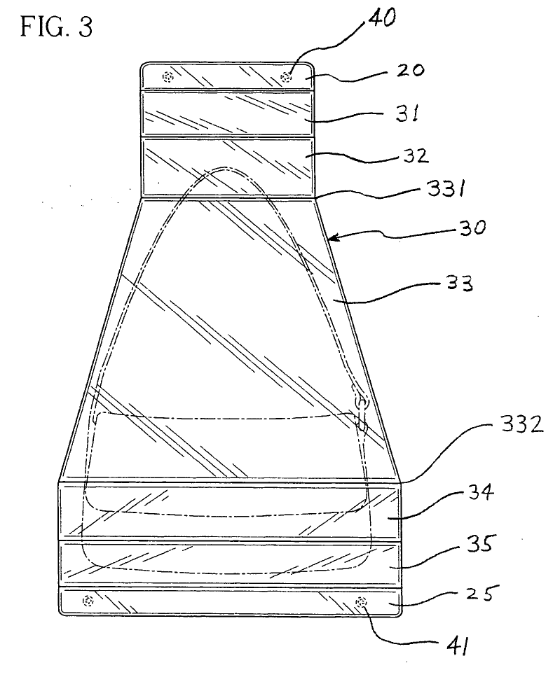

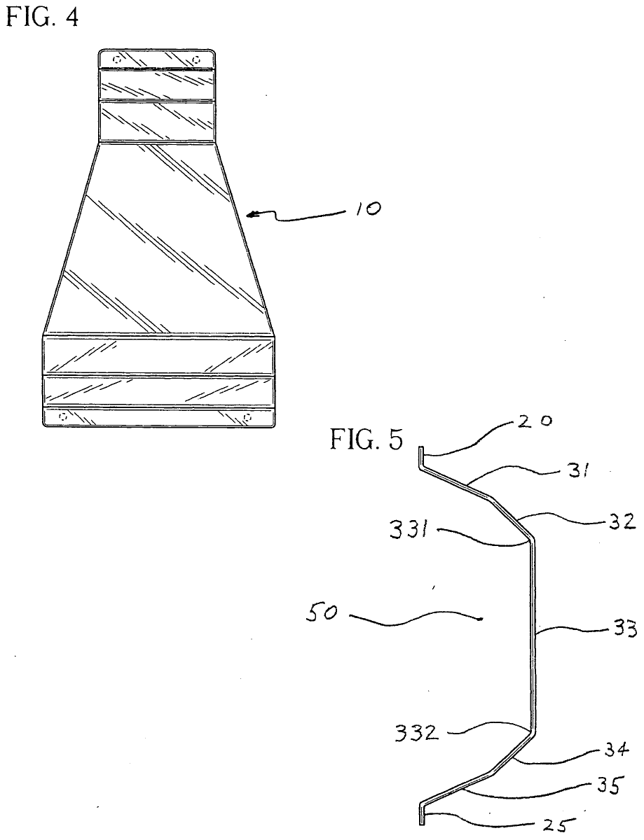

The drawings, FIGS. 1 through 5 show a personal items holder 10 embodying the basic principles and concepts of the present invention. It should be noted that although the figures are directed to the preferred embodiment, other applications of the instant invention are anticipated, as discussed more fully below.

FIGS. 1 through 5 show the personal items holder 10 generally comprising a top mounting portion 20 and a bottom mounting portion 25. These mounting portions 20, 25 are intended for mounting the holder 10 onto a surface 100, such as a wall or door. The holder 10 also includes a middle portion 30. In the preferred embodiment, the middle portion 30 is defined by sub-portions 31-35 that together define the overall middle portion 30. In the preferred embodiment, the top mounting portion 20, the middle portion 30, and the bottom mounting portion 25 are made from one continuous piece of acrylic or plastic sheeting. However, it is understood that the personal items holder 10 can be made from other materials, as well as a plurality of materials. In other words, the portions 20, 25, 30 could be made separately and secured together to form the holder 10.

The middle portion 30 does not generally lie on the same plane as the mounting portions 20, 25, thus defining a storage space 50 comprising the volume of space between the mounting surface 100 and the middle portion 30, which is intended for storing personal items 150. Such personal items include, but are not limited to, purses, handbags, wallets, packages, umbrellas, briefcases, documents, books, magazines, mobile telephones, small portable electronics, keys and the like. Alternatively, the mounting portions 20, 25 can be offset from one another in order to be mounted on different surfaces or one of those mounting portions 20, 25 need not be fixed to a surface.

In the preferred embodiment, the holder 10 is comprised of a single piece of acrylic or plastic. However, a similar overall structure can be achieved using separate connected pieces, laminate compositions, additional coatings, or even made of alternate materials. Acrylic has particular advantages that are well suited to the instant invention. For example, custom shaped pieces are relatively inexpensive and simple to manufacture. Also, the material is lightweight and durable and provides suitable support structure for this application. Further, acrylic sheets can be made transparent, which in the instant invention allows users to continuously view their articles. This adds to the security of the stored personal items by keeping them in plain sight which also reminds users to depart with their things. Further still, messages or advertising can cover portions of the holder 10 as is often useful in commercial settings. Messages or advertising are easily placed on acrylic or plastics by engraved, hot stamping, labeling or any number of other means.

Alternatively, the material of the holder 10 can be made white translucent, colored translucent, solid or even patterned as known in the art. Although a transparent or translucent design is intended for the preferred embodiment, solid designs could have application as well. For example, the instant invention used in an office space work cubicle might be designed with an opaque or solid colored material to keep stored items private and out of view. Further still, while a rigid structure is shown in the preferred embodiment, more flexible materials could be used for a semi or fully collapsible design.

The two mounting portions 20, 25 are intended to provide mounting engagement with a designated mounting surface 100 which is preferably a vertical surface, such as a wall or door. However, it is understood that the mounting surface may be a horizontal surface or a surface oriented at any angle between vertical and horizontal. In the preferred embodiment the mounting surface 100 would be the inside wall or door of a restroom stall. However, it is anticipated that other surfaces could be used for mounting, including fixtures and walls. Additionally, the mounting portions 20, 25 are provided with mounting means 40, 41 for affixing the holder 10 to the mounting surface 100. The mounting means 40, 41 can be comprised of a hole or set of holes in the holder 10 that is or are located in at least one of the two mounting portions 20, 25. In the preferred embodiment, two holes are evenly spaced in each of the two mounting portions 20, 25. The mounting means 40, 41 can be further comprised of fasteners, such as nails or screws that secure the holder 10 to the mounting surface 100. Although screws are illustrated in the preferred embodiment, it is understood that numerous methods are known in the art for fastening such devices to a surface, including adhesive materials and other mechanical fasteners. While mounting holes (not shown) are included in the preferred embodiment, such holes are not necessary and are only made a part of the preferred embodiment as an example and are not intended to limit the invention in any respect. Also, both permanent and semi-permanent means of fastening are anticipated to be within the scope of the present invention.

Positioning the mounting surfaces at two opposite ends of the instant device provides the advantage of distributing or dividing the effective load of the holder 10 on the mounting surface 100. This improves the load bearing capacity of the holder 10 and improves the durability of its installation. Also, it enables the holder 10 to be installed on lightweight walls or doors.

The middle portion 30 encloses or covers the storage area 50, but provides open ends on the two lateral sides. It is important that there be no obstructions or protrusions into or near the storage area 50 that might catch or snag personal items placed there, such as a rigid or flexible member positioned against or near the mounting surface 100 and connecting the mounting portions 20, 25. In the preferred embodiment, the middle portion 30 is comprised of five (5) sections 31, 32, 33, 34, 35. The four portions 31, 32, 34, 35 closest to the two mounting portions 20, 25, provide depth to the holder 10 and are configured neither parallel nor perpendicular (i.e., angled) relative to the mounting surface 100. The fifth or center-middle portion 33 is shown to have the largest surface area and is oriented parallel to the mounting surface 100. In the preferred embodiment, the center-middle portion 33 is tapered so that it is narrower at its top 331 than at its bottom 332. Although the preferred embodiment shows a linear taper, it is understood that the two lateral sides can have varied shapes or styles. Such shapes could include, but are not limited to, a curved taper, a concave or convex curve, or irregular edges on the open ends.

Also, to correspond to this tapered design, the upper-middle portions 31, 32 are narrower than the lower-middle portions 34, 35. This tapered design allows users of the holder to more easily place items in and remove items from the storage area 50 and substantially reduces the amount of material required to manufacture the holder 10, and thus its cost.

However, it is understood that the middle portion 30 can comprise a fewer or greater number of sections than what is illustrated in FIGS. 1-5. In fact, middle portion 30 could even be one curved section. Also, the tapered configuration discussed above, in the center-middle portion 33, could be applied to the overall design, giving the device a more triangular or trapezoidal shape. Alternatively, the tapered configuration need not be used giving the device a more square or rectangular shape.

Alternatively, the instant invention could find application in other areas where temporary storage of items is expected. Obviously, such areas could be either public, private or semi-private, such as the office space cubicle mentioned above or even in a home. Additionally, although the instant disclosure refers to personal items, the above-mentioned holder 10 could be used to hold virtually any item that could be retained by this type of device.

While the invention has been described in connection with one or more embodiments, it is to be understood that the specific mechanisms and techniques which have been described or shown are for illustrative purposes only to provide a basic understanding of the invention, and that many modifications may be made to the invention described without deviating from the scope of the invention. Thus, the scope of the invention should be determined by the appended claims and their legal equivalents, rather than by the examples given.

What is claimed is:

1. A storage device comprising:
a bracket comprising a top mounting portion, a bottom mounting portion, and a middle portion,
said top mounting portion and said bottom mounting portion each being adapted to be mounted to at least one mounting surface,
said middle portion being joined at one end to said top mounting portion and joined at an opposing end to said bottom mounting portion, said middle portion extending outwardly from at least one of said top mounting portion and said bottom mounting portion to define a storage area comprising unobstructed opposing side openings in the absence of a substantially flat member connecting said top mounting portion and said bottom mounting portion thereby providing unimpeded access through the storage area from either side opening; and
a mounting device for securing at least one of said top and bottom mounting portions to said at least one surface.

2. A device as defined by claim 1, wherein at least one section of at least one portion of said bracket is transparent.

3. A device as defined by claim 1, wherein at least one section of at least one portion of said bracket is translucent.

4. A device as defined by claim 1, wherein at least one section of at least one portion of said bracket is opaque.

5. A device as defined by claim 1, wherein said bracket comprises a continuous sheet of material.

6. A device as defined by claim 1, wherein at least one of a message and image is located on said bracket.

7. A device as defined by claim 1, wherein said middle portion comprises a plurality of flat sections.

8. A device as defined by claim 1, wherein said mounting device is located on both said top and bottom mounting portions.

9. A device as defined by claim 1, wherein said mounting device comprises at least one hole provided in at least one of said top and bottom mounting portions, and at least one fastener for mounting said bracket to said surface.

10. A device as defined by claim 1, wherein said bracket comprises at least one tapered section comprising a narrower end and an opposing wider end.

11. A device as defined by claim 10, wherein said at least one tapered section is said middle portion.

12. A device as defined by claim 1, wherein said top mounting portion and said bottom mounting portion are both mounted to the same surface.

13. A method of storing a personal item comprising:
providing a bracket comprising a top mounting portion, a bottom mounting portion, and a middle portion,
adapting said top mounting portion and said bottom mounting portion to be mounted to at least one mounting surface,
joining said middle portion at one end to said top mounting portion, and
joining said middle portion at an opposed end to said bottom mounting portion, and said middle portion extending outwardly from at least one of said top mounting portion and said bottom mounting portion, such that when at least one of said top mounting portion and said bottom mounting portion is mounted to said at least one surface, the space between said middle portion and said at least one mounting surface defines a storage area that has two opposing sides that are not enclosed allowing unobstructed access to said storage area from beyond said bracket, and wherein no protrusions or obstructions inside or adjoining the storage area impede the loading or unloading of items into or out of the bracket through said two opposing sides;
providing a mounting device for securing at least one of said top and bottom mounting portions to said at least one surface; and
at least temporarily placing a personal item inside said storage area.

14. A method as defined by claim 13, providing at least one section of at least one portion of said bracket as transparent, translucent and opaque.

15. A method as defined by claim 13, providing said bracket as a continuous sheet of material.

16. A method as defined by claim 13, further comprising providing at least one of a message and image on said bracket.

17. A method as defined by claim 13, providing said middle portion as a plurality of flat sections.

18. A method as defined by claim 13, providing said bracket comprises at least one tapered section that is narrower at one end than it is at the opposed end.

19. A method as defined by claim 18, wherein said at least one tapered section is said middle portion.

20. A method as defined by claim 13, mounting said top mounting portion and said bottom mounting portion to the same surface.
